(19) United States
(12) Patent Application Publication
(10) Pub. No.: US 2009/0141667 A1
(43) Pub. Date: Jun. 4, 2009

(54) METHOD FOR ROUTING MESSAGE IN WIRELESS NETWORK BASED ON RELAY PROBABILITY

(75) Inventors: Gwang Ja Jin, Daejeon-city (KR); Bong Soo Kim, Daejeon-city (KR); Cheol Sig Pyo, Daejeon-city (KR); Jong Suk Chae, Daejeon-city (KR); Young Ju Hwang, Daejeon-city (KR); Dong Min Kim, Seoul (KR); Seong Lyun Kim, Seoul (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon-city (KR); INDUSTRY-ACADEMIC COOPERATION FOUNDATION, YONSEI UNIVERSITY, Seoul (KR)

(21) Appl. No.: 12/185,506

(22) Filed: Aug. 4, 2008

(30) Foreign Application Priority Data
Nov. 30, 2007 (KR) 10-2007-0123642

(51) Int. Cl. H04B 7/14

(52) U.S. Cl. 370/315

(57) ABSTRACT

Provided is a method for routing a message in a wireless network based on relay probability. The method allows dynamic delivery of a message by calculating the relay probability of each node for message transmission, measuring the strength of a beacon signal received from a destination node, and determining a node that will relay a message based on the relay probability and the strength of beacon signal.

### CROSS-REFERENCE TO RELATED PATENT APPLICATION

This application claims the benefit of Korean Patent Application No. 10-2007-0123642, filed on Nov. 30, 2007, in the Korean Intellectual Property Office, the disclosure of which is incorporated herein in its entirety by reference.

### BACKGROUND OF THE INVENTION

1. Field of the Invention

The present invention relates to a method for routing a message in a network system, and more particularly, to a method for dynamically routing messages in a network system consisting of mobile wireless nodes by calculating the relay probability of each mobile node for message transmission and determining a node that will relay a message based on the relay probability.

The present invention is derived from a research project supported by the Information Technology (IT) Research & Development (R&D) program of the Ministry of Information and Communication (MIC) and Institute of Information Technology Advancement (IITA). [2005-S-038-03, UHF RF-ID and Ubiquitous Networking Technology Development]

2. Description of the Related Art

A wireless sensor network is a collection of multiple cooperative sensor nodes. Each sensor node is driven by a battery and includes a small capacity memory and a processor. Thus, communication protocols for sensor networks should be designed considering energy available, memory usage, and processing efficiency. In particular, routing protocols have to be simple and lightweight. Further, a sensor network should be self-configurable because nodes in the sensor network may disappear or break down at any time. If broken nodes are located within a fixed path, such node or path failure causes retransmission that significantly degrades energy efficiency.

A multi-hop routing technique has been typically applied to deliver messages over a wireless network having the above constraints. For multi-hop routing, an AODV (Ad-Hoc On-Demand Distance Vector) routing based on carrier sensing have been used.

However, the conventional message delivery technique does not only require the use of a separate MAC (Media Access Controller) but also suffers low throughput per node due to high mobility of wireless nodes.

### SUMMARY OF THE INVENTION

The present invention provides a method for routing messages in a wireless network which can provide improved per-node throughput and remove the message loop by calculating the message relay probability of each wireless node and determining a node that will relay a message based on the relay probability.

The objects and advantages of the invention may be realized and attained by means of instrumentalities and combinations particularly set forth in the appended claims.

According to an aspect of the present invention, there is provided a method for delivering a message from a transmission node to a destination node within a wireless network consisting of multiple nodes, including: transmitting RTS (Request-to-Send) signals to neighboring nodes; receiving response signals to the RTS signals from neighboring nodes that have determined to send the response signals based on their relay probability; and determining one of the neighboring nodes that transmitted the response signals as a relay node.

According to another aspect of the present invention, there is provided a method for delivering a message from a transmission node to a destination node within a wireless network, the method including: determining in a relay node that has received a message from the transmission node whether an address of the relay node is equal to an address of the destination node; terminating transmission of the message if the address of the relay node is equal to the address of the destination node; transmitting RTS (Request-to-Send) signals to neighboring nodes if the address of the relay node are not equal to the address of the destination node; receiving response signals to the RTS signals from neighboring nodes that have determined to send the response signals based on their relay probability; and determining one of the neighboring nodes that transmitted the response signals as a next relay node.

According to another aspect of the present invention, there is provided a computer readable medium having embodied thereon a computer program for the method for delivering a message in a wireless network.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a wireless network consisting of multiple nodes according to an embodiment of the present invention;

FIG. 2 illustrates a method for routing a message to select a relay node within a wireless network according to an embodiment of the present invention;

FIG. 3 illustrates a method for transmitting a packet from a source node directly to a destination node if the source node does not receive ACK signals from neighboring nodes that have received RTS (Request-to-Send) signals according to an embodiment of the present invention;

FIG. 4 illustrates a method for retransmitting a packet if a source node does not receive an ACK signal after transmitting a packet to a destination node or relay node according to an embodiment of the present invention;

FIG. 5 illustrates a packet structure for a wireless sensor network system using a basketball routing algorithm according to an embodiment of the present invention;

FIG. 6 illustrates message types defined in the packet structure of FIG. 5;

FIG. 7 illustrates a message loop that can occur during transmission of message via a relay node according to an embodiment of the present invention;

FIG. 8 illustrates a method for preventing the occurrence of a message loop according to an embodiment of the present invention;

FIG. 9 is a flowchart illustrating a method for delivering a message from a source node to a destination node within a wireless network according to an embodiment of the present invention;

FIG. 10 is the graph of hop counts versus the number of nodes when a routing method according to the present invention and AODV (Ad-Hoc On-Demand Distance Vector) routing based on CSMA/CA (Carrier Sense Multiple Access with Collision Avoidance) are applied to a wireless network;

FIGS. 11A and 11B respectively illustrate routing paths in a wireless network consisting of 12 nodes when a routing method according to the present invention and AODV routing are applied; and

FIG. 12 is the graph of per-hop transmission distance versus the number of nodes when a routing method according to the present invention and CSMA/CA based AODV routing are applied to a wireless network.

### DETAILED DESCRIPTION OF THE INVENTION

The present invention will now be described more fully with reference to the accompanying drawings, in which exemplary embodiments of the invention are shown.

Hereinafter, preferred embodiments of the present invention are described in detail with reference to the accompanying drawings. The same reference symbols in different drawings identify the same or corresponding elements. Constructions or processes known in the art may be not described to avoid obscuring the invention in unnecessary detail.

Unless otherwise specified, the terms “comprises” and/or “comprising”, when used in this specification, specify the presence of elements and/or components, but do not preclude the presence or addition of one or more other elements and/or components. In the present invention, the terms “data”, “packet”, “data packet’, “message”, and “signal” are used interchangeably without distinguishing one from the other.

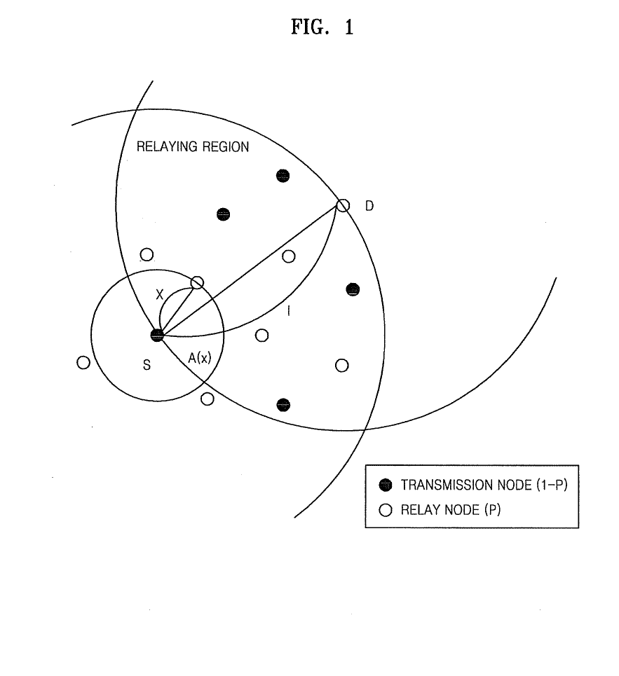

FIG. 1 illustrates a wireless network consisting of multiple nodes according to an embodiment of the present invention.

A method for routing a message via a relay node according to the present invention employs a BR (Basketball Routing) algorithm. Random BR is per-hop-based multi-hop routing that combines mobility of a simple node with routing design. BR allows a mobile node to repeatedly receive and transmit the same packet. BR also provides self-configurability because each node can adaptively (or opportunistically) determine the next forwarder (relay node) without having to know the whole network topology. Further, BR that combines MAC (Medium Access Control) and routing in a cross-layer optimized manner can be usefully applied to a sensor network.

Referring to FIG. 1, the wireless network according to the present embodiment consists of multiple transmission nodes and relay nodes. A transmission node generates its message and transmits the message to other nodes. The transmission node may also be referred to as a source node S that is the counterpart of a destination node D. A relay node R receives data between the source node S and destination node D and transmits the data to another neighbor node. Nodes calculate their relay probability p (0<p<1) of receiving and transmitting a message from/to another neighbor node within a given time slot. A relay probability is a probability of receiving a message from a node and transmitting the message to another node at the location. Each node listens to messages received from other nodes with a probability p and transmits its own message to other nodes with the probability 1−p.

Each node appropriately transmits its own packet to a relay node or directly to a destination node, depending on one or more factors such as distance. By easily controlling the relay probability, MAC and routing in a network can be controlled. For example, if p=0, there is no relay of packet and single-hop transmission occurs such that all nodes can transmit their messages at the same time. As the relay probability p increases, the number of relay nodes in a neighborhood of a transmission node increases (i.e., the number of transmission nodes decreases) and average transmission distance and retransmission delay decrease. However, node's transmission probability 1−p also decreases, which means less transmission opportunities. If p=1, due to the absence of a transmission node within the wireless network, the optimized relay probability is provided and maximum network throughput is achieved.

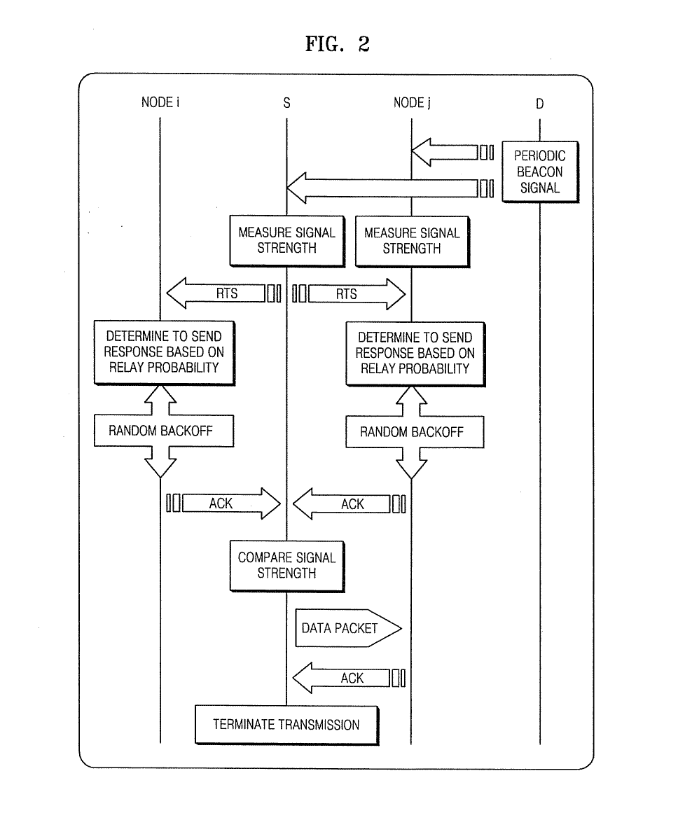

FIG. 2 illustrates a method for routing a message to select a relay node within a wireless network according to an embodiment of the present invention.

Referring to FIG. 2, a message is routed among a source node S, a destination node D, and neighboring nodes i and j within a wireless network.

More specifically, the destination node D periodically broadcasts a beacon signal to the source node S and the neighboring nodes i and j. Upon receipt of the beacon signal, the source node S and the neighboring nodes i and j respectively measure and store the strength of the beacon signal so that all the nodes within the wireless network can obtain the location of the destination node D. Each node also calculates and determines its relay probability p.

The source node S wishing to send a message transmits an RTS Request-to-Send) message to the neighboring nodes i and j within its radio range. The RTS message header contains an identifier (ID) of the source node S that has transmitted the RTS message.

The neighboring nodes i and j that received the RTS message determines whether to send ACK packets based on their relay probability p. To avoid collision, the neighboring nodes i and j wait for short random time slots before transmitting their ACK signals. Each ACK packet header contains the strength of a received beacon signal and ID of a corresponding one of the neighboring nodes i and j.

The source node S receives the ACK signals from the neighboring nodes i and j, compares the strength of the beacon signals contained in the ACK signals, and selects a node that has sent the strongest beacon signal as a relay node. The source node S then sends a data packet to the selected relay node j and terminates its transmission after receiving an ACK signal from the relay node j. The relay node j receiving the data packet repeats the above process performed by the source node S as long as it is not the destination node D.

The above method is multi-hop routing method, since a message is delivered via relay node.

According to the present invention, the probability Pᵣ of successfully transmitting a message by one hop is defined by the following Equation (1) with reference to FIG. 1:

$${P}_{r} [ {γ}_{j} \geq γ ] = {\int }_{0}^{1} {\int }_{0}^{\frac{1}{{γ}^{{z}^{′}}}} {f}_{I , X} ( i , x ) d i d x = \frac{1}{1 - {e}^{- λ pa}} [ 1 + {e}^{\frac{{a}^{2} {p}^{2}}{1 - {p}^{2} {π}^{3} γ}} erf ( \frac{ap}{( 1 - p ) {π}^{3 / 2} \sqrt{γ}} ) - {e}^{\frac{{a}^{2} {p}^{2}}{{( 1 - p )}^{2} {π}^{3} γ}} erf ( \frac{2 ap + {λ ( 1 - p )}^{2} {π}^{3} γ}{2 ( 1 - p ) {π}^{3 / 2} \sqrt{γ}} ) - {e}^{- λ pa} erfc ( \frac{{π}^{3 / 2} λ ( 1 - p ) \sqrt{γ}}{2} ) ] \qquad ( 1 )$$

where p, γ, and γⱼ respectively denote relay probability, target SIR (Signal to Interference Ratio) and received SIR at node j, and I, X, a(=1.3), and λ respectively denote total interference power, distance from source node to closest relay node j, constant for denoting the area A(x) in the relaying region and source node density.

The received SIR at a receiving node (relay node or destination node) should be greater than the target SIR γ in order for the source node S to successfully transmit a packet to a relay node or destination node.

The number N_{B} of expected BEB (Binary Exponential Backoff) slots can be calculated by Equation (2) using transmission failure probability:

$${N}_{B} = \frac{1}{2} ( \frac{1}{1 - {p}_{cB}} + \frac{{W}_{0}}{1 - 2 {p}_{cB}} ) - 1 \qquad ( 2 )$$

where W₀ and p_{cB} respectively denote the minimum contention window size and transmission failure probability per hop of case B.

The number k of hops taken by a message being delivered from the source node S to the destination node D can be computed using Equation (3):

$$k ≃ E [ \frac{1}{X} ] = \frac{\sqrt{π} \sqrt{λ pa}}{1 - {e}^{- λ pa}} erf ( \sqrt{λ pa} ) \qquad ( 3 )$$

where λ, p, a(=1.3), and X respectively denote source node density, relay probability, constant for denoting the area A(x) in the relaying region, and distance from source node to closest relay node j.

In multi-hop routing, traverse time D_{B} can be computed using Equation (4):

$$\begin{matrix}{D}_{B} ( γ , p ) = [ {\sum }_{s = 0}^{∞} ( {kN}_{B} + s ) ( \frac{k + s - 1}{s} ) {( 1 - p )}^{λ} {p}^{s} ] \cdot {t}_{slot} \\ = [ k ( {N}_{B} + \frac{p}{1 - p} ) ] \cdot {t}_{slot}\end{matrix} \qquad ( 4 )$$

where γ, p, k, s, and tₛₗₒₜ respectively denote target SIR, relay probability, the number of hops, the number of time slots that a packet stays at a relay node until the relay node gets a chance to transmit, and the duration of each time slot.

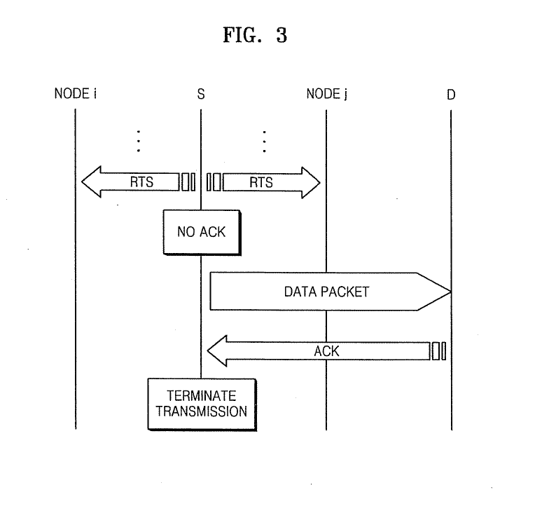

FIG. 3 illustrates a method for transmitting a packet from a source node S directly to a destination node D when the source node S does not receive ACK signals from neighboring nodes i and j that received RTS signals according to an embodiment of the present invention.

Referring to FIG. 3, a message is routed among the source node S, the destination node D, and the neighboring nodes i and j within a wireless network.

More specifically, if the source node S does not receive ACK signals from neighboring nodes i and j after transmitting a RTS signal to the neighboring nodes i and j, it attempts to send a desired packet directly towards the destination node D.

In this case, the source node S does not expect the packet to necessarily reach the destination node D and terminates its transmission only after receiving an ACK signal from the destination node D.

In the present embodiment, the probability Pᵣ of successful transmission can be computed using Equation (5):

$$\begin{matrix}{P}_{r} = [ {γ}_{j} \geq γ ] = {\int }_{0}^{\frac{1}{γ}} {f}_{I} ( i ) d i \\ = erfc ( \frac{{π}^{3 / 2} λ ( 1 - p ) \sqrt{γ}}{2} )\end{matrix} \qquad ( 5 )$$

where p, γ, γⱼ, I, and λ respectively denote relay probability, target SIR, received SIR at node j, total interference power, and source node density.

The number N_{A} of expected BEB slots can be calculated using Equation (6):

$${N}_{A} = \frac{1}{2} ( \frac{1}{1 - {p}_{cA}} + \frac{{W}_{0}}{1 - 2 {p}_{cA}} ) - 1 \qquad ( 6 )$$

where W₀ and p_{cA} respectively denote the minimum contention window size and transmission failure probability per hop of case A.

The expected traverse time D_{A} can be computed using Equation (7):

$$\begin{matrix}{D}_{A} ( γ , p ) = [ {\sum }_{s = 0}^{∞} ( {N}_{A} + s ) ( 1 - p ) {p}^{s} ] \cdot {t}_{slot} \\ = [ ( {N}_{A} + \frac{p}{1 - p} ) ] \cdot {t}_{slot}\end{matrix} \qquad ( 7 )$$

where p, γ, s, and tₛₗₒₜ respectively denote relay probability, target SIR, the number of hops, the number of time slots that a packet stays at a relay node until the relay node gets a chance to transmit, and the duration of each time slot.

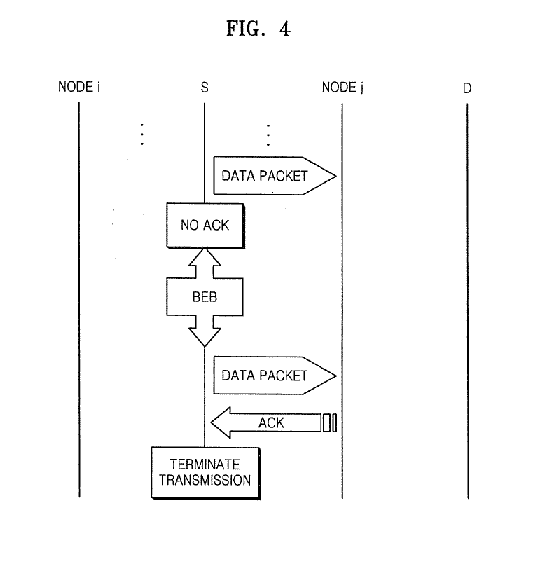

FIG. 4 illustrates a method for retransmitting a packet if a source node S does not listen to an ACK signal after transmitting a packet to a destination node D or neighboring relay nodes i and j according to an embodiment of the present invention.

Referring to FIG. 4, if the source node S does not listen to an ACK signal after transmitting a packet to the destination node D or neighboring relay nodes according to an embodiment of the present invention, i.e., the message transmission fails, the source node S retransmits a message or packet using a BEB scheme. A BEB scheme uses three parameters, i.e., backoff stage, backoff counter, and contention window to reduce the probability of collision between packets being transmitted by increasing backoff stage by one and doubling a content window size after a packet collision. The contention window size is the range of possible backoff counter values. Such packet retransmission occurs after a random backoff slot while not affecting the transmission probability 1−p.

The source node terminates its transmission after receiving an ACK signal.

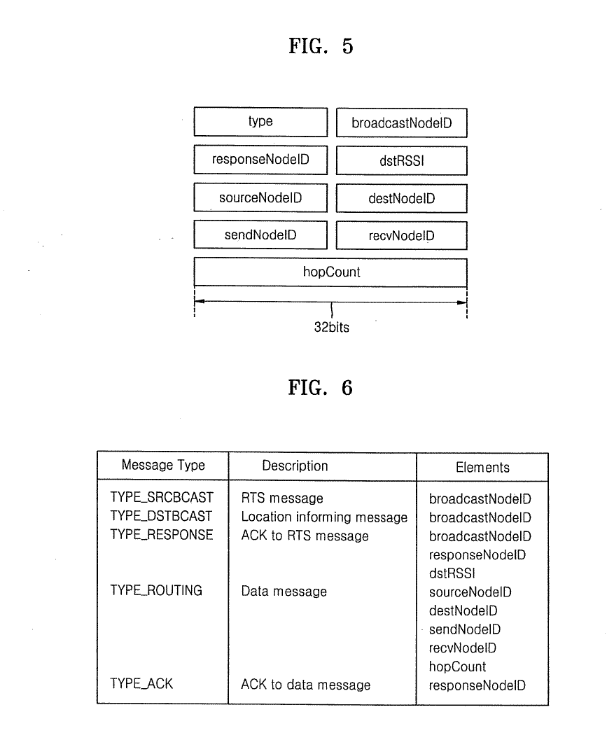

FIG. 5 illustrates a packet structure for a wireless sensor network system using a BR algorithm according to an embodiment of the present invention. FIG. 6 illustrates message types defined in the packet structure of FIG. 5.

Referring to FIG. 5, according to the present embodiment, a packet consists of eight 16-bit fields and one 32-bit hopCount field. Eight 16-bit fields include a type field indicating message types, a broadcastNodeID field indicating an ID of a broadcasting node, a responseNodeID field indicating an ID of a responding node, a dstRSSI field indicating a RSSI (Received Signal Strength Intensity/Indication (RSSI) of a message at a destination node, a sourceNodeID field indicating an ID of a source node that generates a message, a sendNodeID field indicating an ID of a current relay node currently forwarding a message, and a recvNodeID indicating an ID of a next relay node subsequently forwarding the message. The 32-bit hopCount field indicates the number of relays.

Referring to FIG. 6, messages being transmitted within a wireless sensor network system according to an embodiment of the present invention include a RTS message, a location informing message, an ACK to RTS message, a data message, and an ACK to data message.

The RTS message and the location informing message carry ID of a broadcasting node (broadcastNodeID) and the ACK to RTS message carries ID of a broadcasting node (broadcastNodeID), ID of a responding node (responseNodeID), and RSSI of a message at destination node (dstRSSI). The data message carries ID of a transmission node (sourceNodeID), ID of destination node (destNodeID), and ID of a current relay node (sendNodeID), ID of a next relay node (recvNodeID), and the number of hops (hopcount). The ACK to data message carries ID of a responding node (responseNodeID).

For example, when sensor node powered on, the sensor node listens to a channel for receiving a packet. A destination node periodically broadcasts a message TYPE_DSTBCAST to notify other nodes of its location. Each node that received the message TYPE_DSTBCAST measures a RSSI of the message and stores the measured RSSI into dstRSSI. A source node broadcasts a message TYPE_SRCBCAST in order to select a next relay node. Neighboring nodes that received the message TYPE_SRCBCAST determines whether to transmit a message TYPE_RESPONSE based on their relay probability. The source node then compares its dstRSSI with dstRSSI contained in the received message TYPE_RESPONSE. If the source node has the largest dstRSSI value, it transmits a message TYPE_ROUTING directly to the destination node. If not, the source node transmits the message TYPE_ROUTING via a relay node with the largest dstRSSI value. The relay node that received the message TYPE_ROUTING sends a message TYPE_ACK to the source node and checks whether destNodeID is equal to its local address. If both are equal, routing is terminated. If not, the relay node that received the message TYPE_ROUTING broadcasts a message TYPE_SRCBCAST. Then, the above selection and routing procedures are repeated.

If a source node does not receive an ACK signal after transmitting a message via a relay node or directly to a destination node, which means message transmission fails, the source node may retransmit a message or data using BEB.

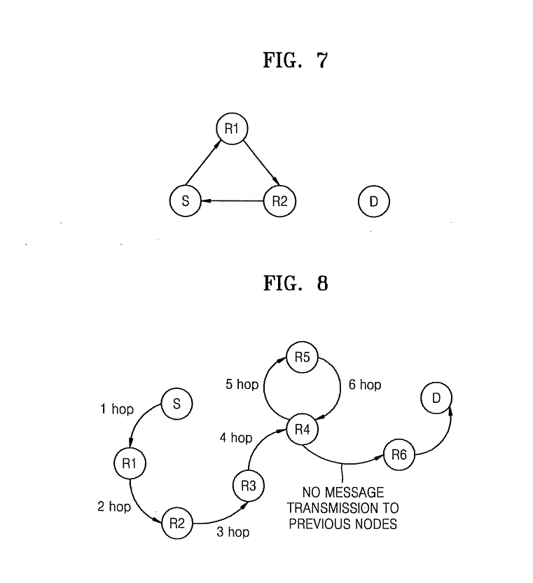

FIG. 7 illustrates a message loop that can occur during transmission of message via a relay node according to an embodiment of the present invention.

Referring to FIG. 7, a message continues to repeatedly circulate between nodes S, R1 and R2 without being delivered to the destination node D, which is referred to as a “message loop”. A message loop may occur in a static environment. That is, a message routing method according to the present invention tends to create a message loop because it allows a node to repeatedly relay the same packet.

According to the present invention, a hop count indicating the number of hops a message is delivered is used to prevent a message loop.

FIG. 8 illustrates a method for preventing the occurrence of a message loop according to an embodiment of the present invention.

According to the present embodiment, a loop-free mechanism is used to prevent a message from circulating between specific nodes instead of being delivered to a destination node. More specifically, a loop threshold is preset and if hop count exceeds the loop threshold at a node, the message is not forwarded to the previous node that has transmitted the same message to a current relay node. The loop-free mechanism enables transmission of the message to the destination node.

Referring to FIG. 8, if a hop count from a source node S is 6 that exceeds a loop threshold of 5 hops, a node R₄ forwards a message to node R₆ other than previous nodes R₃ and R₅ that transmitted the message to the node R₄ so that the message is delivered to the destination node D.

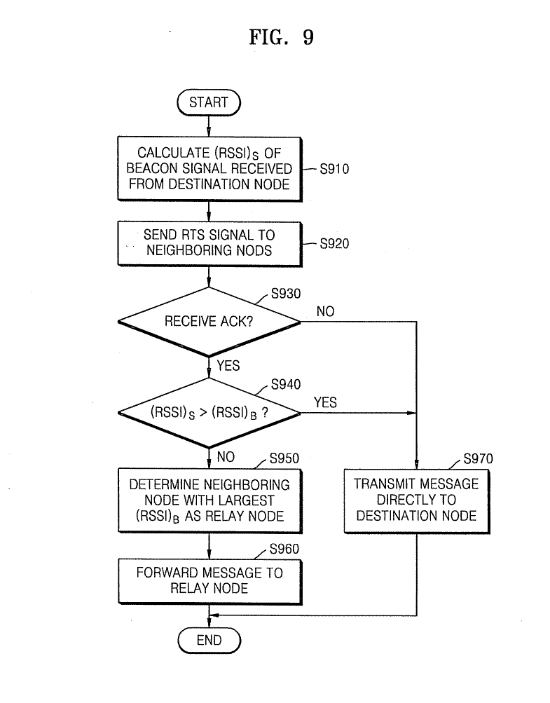

FIG. 9 is a flowchart illustrating a method for delivering a message from a source node to a destination node within a wireless network according to an embodiment of the present invention.

Referring to FIG. 9, nodes constituting a wireless network, including a source node having a message to transmit to a destination node, receive beacon signals from the destination node and calculates and stores the strength (RSSI)_{S} of the beacon signals (S910).

The source node transmits RTS signals to neighboring nodes to deliver a message (S920).

The source node determines whether it has received response signals (ACKs) to the RTS signals from the neighboring nodes (S930).

When the source node receives the response signals from the neighboring nodes, it compares its (RSSI)_{S} with (RSSI)_{B} contained in the response signals, which denote the strength of beacon signals that the respective neighboring nodes calculate after receiving the beacon signals from the destination node (S940). If the source node does not receive a response signal from the neighboring nodes, it transmits the message directly to the destination node (S970).

When (RSSI)_{S} is less than (RSSI)_{B}, the source node selects a neighboring node with the largest (RSSI)_{B} as a relay node (S950) and forwards the message to the selected relay node (S960). When (RSSI)_{S} is greater than (RSSI)_{B}, the source node delivers the message directly to the destination node (S970). When (RSSI)_{S} is equal to the largest (RSSI)_{B}, the source node transmits the message directly or via one of the neighboring nodes having the largest (RSSI)_{B} equal to (RSSI)_{S} as a relay node to the destination node.

A node that has been selected as a relay node to receive the message determines whether a destination address contained in the message is equal to its own address. If both of the addresses are equal, which means the relay node is the destination node, message routing is completed. If not, operations S920 through S970 are repeated. At operation S940, the relay node compares its RSSI with (RSSI)_{B} measured at its neighboring nodes.

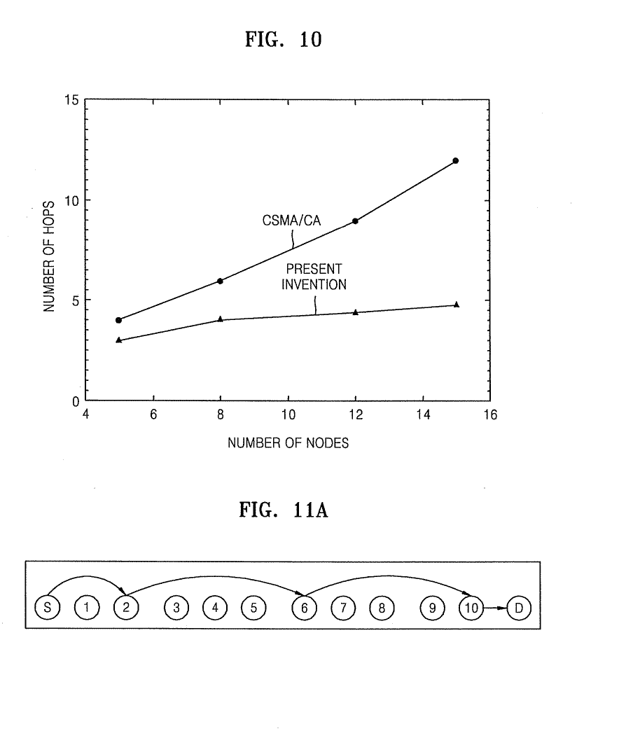

FIG. 10 shows comparison of the number of hops needed to route a packet from a source node to a destination node when a routing method according to the present invention and AODV (Ad-Hoc On-Demand Distance Vector) routing based on CSMA/CA (Carrier Sense Multiple Access with Collision Avoidance) are applied.

To facilitate comparison between the routing method of the present invention and conventional AODV routing, 5 through 15 nodes were located in a 2.05M×14M space while the source node and the destination node were at either end thereof with relay nodes lying therebetween. A transmission range of each node and the optimized relay probability p were set to 6 M and 0.83, respectively. Response wait time RESPONSE_WAIT_TIME, ACK wait time ACK_WAIT_TIME, and RTS transmission BCAST_TIME, and loop threshold were respectively set to 5 s, 2 s, 10 s, and 10 hops.

Referring to FIG. 10, the graph shows that the routing method according to the present invention requires a smaller number of hops than AODV routing. Further, as the number of network nodes increases, the routing method according to the present invention provides significantly improved performance compared to AODV routing.

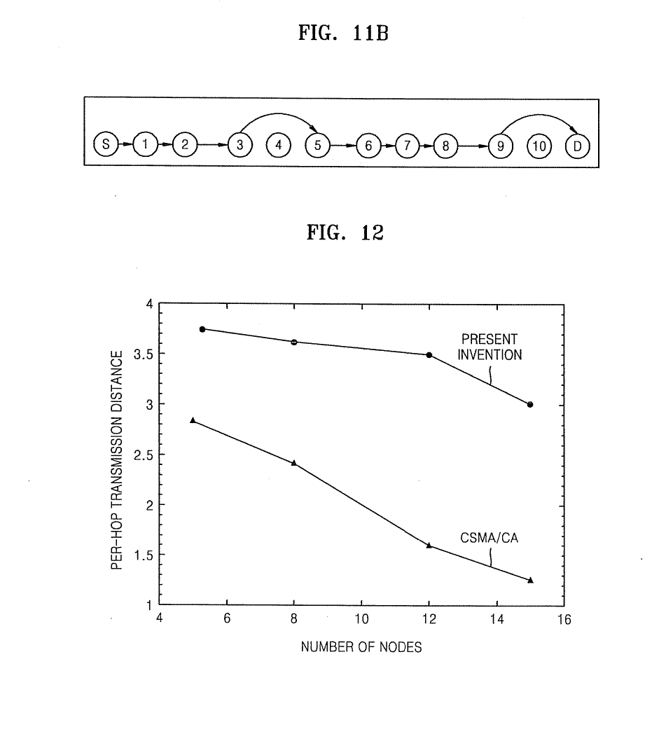

For example, when a routing method according to the present invention is applied within a wireless network consisting of 12 nodes as shown in FIG. 11A, four hops may be taken to deliver a message from a source node S to a destination node D because it is possible to skip same nearby nodes due to the opportunistic nature of the wireless network. When CSMA/CA-based AODV routing is applied as shown in FIG. 11B, 9 hops may be taken for almost all nodes to relay a message.

FIG. 12 is the graph of per-hop transmission distance versus the number of nodes. The same parameters as described with reference to FIG. 10 are used for comparison between the present invention and AODV routing.

Referring to FIG. 12, as the number of nodes increases, a per-hop transmission distance decreases when routing according to the present invention and CSMA/CA-based AODV routing are applied. Routing according to the present invention offers a longer per-hop transmission distance than AODV routing, thereby reducing the number of hops.

As described above, a method for routing a message according to the present invention allows dynamic delivery of a message by calculating the relay probability of each node for message transmission, measuring the strength of a beacon signal received from a destination node, and determining a node that will relay a message based on the relay probability and the strength of beacon signal, thereby providing improved efficiency in message transmission.

The present invention also provides message routing based on relay probability, thereby providing improved per-node throughput without the need for a separate MAC layer.

The present invention also removes a message loop within a network, thereby allowing efficient message transmission.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.)

Particular terms may be defined to describe the invention in the best manner. Accordingly, the meaning of specific terms or words used in the specification and the claims should not be limited to the literal or commonly employed sense, but should be construed in accordance with the spirit of the invention.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for delivering a message from a transmission node to a destination node within a wireless network, the method comprising:
transmitting RTS (Request-to-Send) signals to neighboring nodes;
receiving response signals to the RTS signals from neighboring nodes that have determined to send the response signals based on their relay probability; and
determining one of the neighboring nodes that transmitted the response signals as a relay node.

2. The method of claim 1, wherein the determining of one of the neighboring nodes as a relay node comprises:
comparing the strengths of beacon signals contained in the response signals, which the respective neighboring nodes calculate after receiving the beacon signals from the destination node; and
determining a neighboring node with the largest beacon signal strength as a relay node.

3. The method of claim 2, further comprising, if the strength of a beacon signal calculated by the transmission node is greater than the strengths of beacon signals calculated by the neighboring nodes, transmitting the message directly to the destination node.

4. The method of claim 1, further comprising, unless receiving the response signals from the neighboring nodes, transmitting the message directly to the destination node.

5. The method of claim 1, further comprising, unless receiving an acknowledgement (ACK) after transmitting a message via the relay node or directly to the destination node, retransmitting the message using BEB (Binary Exponential Backoff).

6. A method for delivering a message from a transmission node to a destination node within a wireless network, the method comprising:
determining in a relay node that has received a message from the transmission node whether an address of the relay node is equal to an address of the destination node;
terminating transmission of the message if the address of the relay node is equal to the address of the destination node;
transmitting RTS (Request-to-Send) signals to neighboring nodes if the address of the relay node is not equal to the address of the destination node;
receiving response signals to the RTS signals from neighboring nodes that have determined to send the response signals based on their relay probability; and
determining one of the neighboring nodes that transmitted the response signals as a next relay node.

7. The method of claim 6, wherein the determining of one of the neighboring nodes as a next relay node comprises:
comparing the strengths of beacon signals contained in the response signals, which the respective neighboring nodes calculate after receiving the beacon signals from the destination node; and
determining a neighboring node with the largest beacon signal strength as a next relay node.

8. The method of claim 7, further comprising if the strength of a beacon signal calculated by the relay node is greater than the strengths of beacon signals calculated by the neighboring nodes, transmitting the message directly to the destination node.

9. The method of claim 6, further comprising, unless receiving the response signals from the neighboring nodes, transmitting the message directly to the destination node.

10. The method of claim 6, further comprising, unless receiving an acknowledgment (ACK) after transmitting a message to the next relay node or the destination node, retransmitting the message using BEB (Binary Exponential Backoff).

11. The method of claim 6, wherein if the number of hops of the node which is received the message exceeds a preset hop count, a next relay node is determined among nodes except the nodes that transmitted the message.
